(19) United States
(12) Patent Application Publication
(10) Pub. No.: US 2026/0116073 A1
(43) Pub. Date: Apr. 30, 2026

(54) Maintenance Method And Recording Apparatus

(71) Applicant: SEIKO EPSON CORPORATION, Tokyo (JP)

(72) Inventors: Ippei OKUDA, Shiojiri (JP); Shiho HAIZUKA, Shiojiri (JP); Toshio ARIMURA, Shiojiri (JP); Ryoji FUJIMORI, Suwa (JP); Tomohiro NUMAJIRI, Shiojiri (JP)

(21) Appl. No.: 19/372,749

(22) Filed: Oct. 29, 2025

(30) Foreign Application Priority Data
Oct. 30, 2024 (JP) 2024-190518

(51) Int. Cl. B41J 2/165; B41J 11/00; C09D 9/00

(52) U.S. Cl. CPC B41J 2/16552; B41J 2/16532; B41J 11/002; C09D 9/005; B41J 2002/16558; B41P 2235/20; B41P 2235/27

(57) ABSTRACT

A maintenance method according to an embodiment of the present disclosure is a maintenance method for a recording apparatus including an ink jet head having a nozzle that ejects a water-based ink composition, the maintenance method including a leaving-to-stand step of performing leaving-to-stand with a nozzle surface in which the nozzle of the ink jet head is formed being in contact with an absorbing member containing a maintenance liquid.

The present application is based on, and claims priority from JP Application Serial Number 2024-190518, filed Oct. 30, 2024, the disclosure of which is hereby incorporated by reference herein in its entirety.

### BACKGROUND

### 1. Technical Field

The present disclosure relates to a maintenance method and a recording apparatus.

### 2. Related Art

Ink jet recording methods can record high-definition images with a relatively simple apparatus and are rapidly developed in various fields. Among them, an ink ejection failure may occur due to clogging of a nozzle of an ink jet head, and thus various studies have been made on the cleaning of the nozzle.

For example, JP-A-2021-154614 discloses a maintenance method in which a maintenance liquid is attached to a nozzle surface or a wiping member, and the nozzle surface is wiped with the wiping member.

However, this method is still insufficient in terms of reducing the amount of maintenance liquid used and obtaining more excellent cleaning properties (nozzle recoverability).

### SUMMARY

An aspect of a maintenance method according to the present disclosure is a maintenance method for a recording apparatus including an ink jet head having a nozzle that ejects a water-based ink composition, the maintenance method including a leaving-to-stand step of performing leaving-to-stand with a nozzle surface in which the nozzle of the ink jet head is formed being in contact with an absorbing member containing a maintenance liquid.

An aspect of a recording apparatus according to the present disclosure is a recording apparatus that performs maintenance by the maintenance method of the above aspect, the recording apparatus including the ink jet head, the absorbing member, and the maintenance liquid.

### BRIEF DESCRIPTION OF THE DRAWINGS

FIG. 1 is a schematic cross-sectional view representing a state in which an absorbing member is brought into contact with a nozzle forming surface.

FIG. 2 is a schematic cross-sectional view representing a state of suction from a nozzle of an ink jet head.

FIG. 3 is a schematic cross-sectional view schematically showing an ink jet recording apparatus.

FIG. 4 is a perspective view showing an example of a configuration around a carriage of the ink jet recording apparatus.

FIG. 5 is Table 1 showing the composition examples of a maintenance liquid.

FIG. 6 is Table 2 showing the composition examples of an ink composition.

FIG. 7 is Table 3 showing the evaluation results of Examples and Reference Examples.

### DESCRIPTION OF EMBODIMENTS

Embodiments of the present disclosure will be described below. The embodiments described below describe examples of the present disclosure. The present disclosure is not limited to the following embodiments and includes various modifications made without changing the gist of the present disclosure. It is noted that not all of the configurations described below are essential configurations of the present disclosure.

In the present specification, a numerical range indicated by using “to” means a range including numerical values described before and after “to” as a lower limit value and an upper limit value.

In the present specification, “(meth)acrylic” means acrylic or methacrylic, and “(meth)acrylate” means acrylate or methacrylate.

### 1. Maintenance Method

A maintenance method according to an embodiment of the present disclosure is a maintenance method for a recording apparatus including an ink jet head having a nozzle that ejects a water-based ink composition, the maintenance method including a leaving-to-stand step of performing leaving-to-stand with a nozzle surface in which the nozzle of the ink jet head is formed being in contact with an absorbing member containing a maintenance liquid.

When the nozzle of the ink jet head is clogged, an ink ejection failure may occur, and it is necessary to clean the clogging by maintenance. In particular, since the water-based ink composition may contain a fixing resin such as resin particles, when the ink is dried, the ink is, for example, solidified in the nozzle, and thus a nozzle ejection failure is likely to occur.

As a maintenance method in the related art, there is a method in which a nozzle surface is immersed in a liquid surface of a maintenance liquid charged into a cap. However, this method needs to use a large amount of the maintenance liquid, and in addition, the maintenance liquid is easily evaporated. In addition, in this method, an air layer is likely to be formed between the liquid surface of the maintenance liquid and the ink in the nozzle, and the maintenance liquid cannot enter the ink inside the nozzle, and thus sufficient cleaning cannot be performed in some cases.

In addition, in a method of attaching the maintenance liquid to the nozzle surface by spraying or the like, the maintenance liquid may not sufficiently enter the inside of the nozzle, and the maintenance liquid is easily evaporated immediately after being attached to the nozzle surface, and thus it cannot be said that the cleaning properties are sufficient.

It has been found this time that excellent nozzle recoverability can be obtained by a maintenance method in which the maintenance liquid is contained in an absorbing member that can absorb a liquid, and performing leaving-to-stand with the absorbing member being in contact with the nozzle surface. With such a method, excellent nozzle recoverability is obtained even with a smaller amount of the maintenance liquid than that in the method of immersing the nozzle surface in the liquid surface of the maintenance liquid charged into the cap. In addition, since the maintenance liquid is contained in the absorbing member, it is possible to inhibit the evaporation of the maintenance liquid and to cause the maintenance liquid to enter the inside of the nozzle.

Each step of the maintenance method according to the present embodiment will be described below.

### 1.1 Leaving-to-Stand Step

The maintenance method according to the present embodiment includes a leaving-to-stand step of performing leaving-to-stand with a nozzle surface in which the nozzle of the ink jet head is formed being in contact with an absorbing member containing a maintenance liquid.

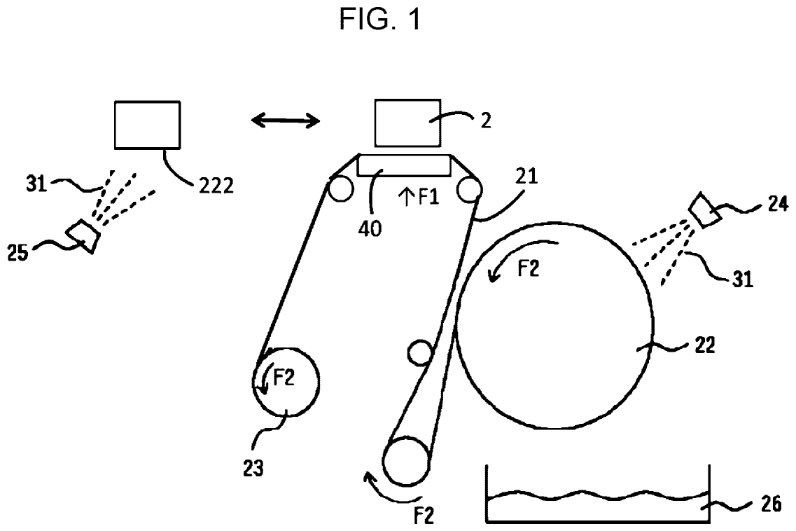

FIG. 1 is a schematic cross-sectional view representing a state in which the absorbing member (a cloth wiper) is brought into contact with the nozzle surface (a nozzle forming surface) in which the nozzle of the ink jet head is formed. FIG. 1 is a diagram of a state in which an absorbing member 21 is pressed against a nozzle forming surface 222 of an ink jet head 2 in an arrow F1 direction.

### 1.1.1 Absorbing Member

The absorbing member is not particularly limited so long as it can absorb and hold a liquid such as a maintenance liquid, and a sponge, a fabric such as a woven fabric or a non-woven fabric, or the like can be used. When the absorbing member is a fabric, the constituent fibers thereof are not particularly limited, and examples thereof include natural fibers such as cellulose fibers and synthetic fibers such as polyester fibers. Among these, natural fibers are preferable, and cellulose fibers are more preferable. Since the cellulose fibers are swollen by water, the fibers are softened by the maintenance liquid, and the abrasion of a water-repellent film of the nozzle forming surface can be further reduced in some cases. In addition, since foreign substances enter the gaps between the swollen cellulose fibers, the cleaning properties also tend to be further improved.

The absorbing member shown in FIG. 1 is a long fabric, and the absorbing member 21 before use is fed from a first roll 22 and the used absorbing member 21 is wound from a second roll 23. With this, the new absorbing member 21 before use can come into contact with the nozzle forming surface 222. Therefore, it is possible to prevent the nozzle forming surface 222 from being re-contaminated by an ink composition that has permeated the used absorbing member 21 due to the used absorbing member 21 coming into contact with the nozzle forming surface 222 again.

### 1.1.2 Method for Attaching Maintenance Liquid

In the leaving-to-stand step, the method of attaching the maintenance liquid to the absorbing member is not particularly limited, and examples thereof include a method of attaching the maintenance liquid to the nozzle surface or the absorbing member by, for example, injecting, dropping, or applying the maintenance liquid, and a method of impregnating the absorbing member with the maintenance liquid.

Therefore, the maintenance method according to the present embodiment may be a method in which the maintenance liquid is attached to the nozzle surface, and the nozzle surface to which the maintenance liquid is attached is brought into contact with the absorbing member to perform leaving-to-stand, or a method in which the maintenance liquid is attached to the absorbing member, and the nozzle surface is brought into contact with the absorbing member to which the maintenance liquid is attached to perform leaving-to-stand. With the maintenance method according to the present embodiment, excellent nozzle recoverability can be obtained in any leaving-to-stand mode.

The ink jet head 2 has the nozzle forming surface 222 in which a nozzle is formed on its lower surface in the figure.

As a mode of attaching the maintenance liquid to the nozzle surface, and bringing the nozzle surface to which the maintenance liquid is attached into contact with the absorbing member to perform leaving-to-stand, for example, in FIG. 1, by injecting a maintenance liquid 31 by a second injector 25 to attach the maintenance liquid 31 to the nozzle forming surface 222 (the nozzle surface), and pressing the absorbing member 21 against the nozzle forming surface 222 to which the maintenance liquid 31 is attached in the arrow F1 direction, the absorbing member 21 can be brought into contact with the nozzle forming surface 222 to perform leaving-to-stand while impregnating the absorbing member 21 with the maintenance liquid 31.

The ink jet head 2 can be moved in the left-to-right direction in the figure by a mechanism (not shown) that moves the ink jet head. The maintenance liquid is attached to the nozzle forming surface 222 of the ink jet head 2 at a position of the ink jet head 2 positioned on the left of the figure, and the ink jet head 2 is moved to a position of the ink jet head 2 on the right of the figure to perform maintenance.

As a mode of attaching the maintenance liquid to the nozzle surface, and bringing the nozzle surface to which the maintenance liquid is attached into contact with the absorbing member to perform leaving-to-stand, for example, in FIG. 1, by injecting the maintenance liquid 31 to the first roll 22 around which the absorbing member 21 is wound by a first injector 24, or attaching the first roll 22 around which the absorbing member 21 is wound to a pool 26 of the maintenance liquid 31, the maintenance liquid 31 is attached to the absorbing member 21, and by pressing the absorbing member 21 impregnated with the maintenance liquid 31 against the nozzle forming surface 222 in the arrow F1 direction, the nozzle forming surface 222 can be brought into contact with the absorbing member 21 to perform leaving-to-stand.

Note that the position at which the maintenance liquid 31 is attached to the absorbing member 21 at a stage before reaching the nozzle forming surface 222 is not limited to the position in FIG. 1, and the attachment of the maintenance liquid 31 may be performed to the absorbing member 21 that is fed out from the first roll 22 in an arrow F2 direction at any stage before reaching the nozzle forming surface 222. For example, the position may be a position closer to the nozzle forming surface 222. For example, the position may be a position immediately before a pressing member 40 that presses the absorbing member 21 in the arrow F1 direction.

The pressing member 40 moves in the F1 direction to push up the absorbing member 21 in the F1 direction. The pressing member 40 is, for example, a plate-shaped member, and moves in the F1 direction by a mechanism (not shown) that moves the pressing member. Due to the movement, the absorbing member 21 is pushed up in the F1 direction, comes into contact with the nozzle forming surface 222, and presses the nozzle forming surface 222. The absorbing member 21 can come into contact with the nozzle forming surface 222 through the surface.

The leaving-to-stand is performed in a state in which the absorbing member 21 is in contact with the nozzle forming surface 222 without changing the relative position between the absorbing member 21 and the nozzle forming surface 222 in the left-to-right direction in the figure. This is the leaving-to-stand.

During a time in which the leaving-to-stand step or a wiping step described below is not performed, the pressing member 40 may move in a direction opposite to F1 to make a state in which the absorbing member 21 is not in contact with the nozzle forming surface 222.

The content of the maintenance liquid of the absorbing member in the leaving-to-stand step is preferably 10 mg/inch² or more, more preferably 20 mg/inch² or more, even more preferably 30 mg/inch² or more, particularly preferably 40 mg/inch² or more, and more particularly preferably 50 mg/inch² or more. In particular, when the content of the maintenance liquid of the absorbing member is 30 mg/inch² or more, the nozzle recoverability tends to be more excellent.

The content of the maintenance liquid of the absorbing member is the content of the maintenance liquid of the portion of the absorbing member with which the nozzle forming surface is in contact in the leaving-to-stand step.

In addition, the upper limit value of the content of the maintenance liquid of the absorbing member in the leaving-to-stand step is not particularly limited, and is preferably 200 mg/inch² or less, more preferably 150 mg/inch² or less, even more preferably 100 mg/inch² or less, and particularly preferably 80 mg/inch² or less.

### 1.1.3 Leaving-to-Stand

In FIG. 1, the leaving-to-stand is performed with the absorbing member 21 being in contact with and pressed against the nozzle forming surface 222 of the ink jet head 2 in the arrow F1 direction.

The pressing load of the absorbing member 21 against the nozzle forming surface 222 is not particularly limited so long as the nozzle forming surface 222 is in contact with the absorbing member 21, and is preferably 8 gf/cm or more, more preferably 15 gf/cm or more, even more preferably 25 gf/cm or more, and particularly preferably 30 gf/cm or more. When the pressing load is within the above range, the effect of causing the absorbing member to absorb the ink from the nozzle to suck out the ink from the nozzle is further exhibited, and the nozzle recoverability tends to be more excellent.

On the other hand, the upper limit value of the pressing load of the absorbing member 21 against the nozzle forming surface 222 is not particularly limited, and is preferably 300 gf/cm or less, more preferably 200 gf/cm or less, even more preferably 100 gf/cm or less, and particularly preferably 50 gf/cm or less. When the pressing load is within the above range, the storage properties of a liquid-repellent film to be formed on the nozzle forming surface tends to be further improved.

Note that the load referred to here is a value obtained by dividing the sum of loads applied to the ink jet head 2 by a contact length (that is, an average linear pressure). Further, the contact length is a contact length in the longitudinal direction of the ink jet head 2 and the absorbing member 21, and when a nozzle plate cover and the absorbing member are in contact with each other, the contact length also includes the length thereof.

The leaving-to-stand time in the leaving-to-stand step is preferably 30 seconds or more, more preferably 1 minute or more, even more preferably 2 minutes or more, still even more preferably 4 minutes or more, and particularly preferably 5 minutes or more. When the leaving-to-stand time of the leaving-to-stand step is the above range or more, the nozzle recoverability tends to be more excellent.

On the other hand, the leaving-to-stand time in the leaving-to-stand step is not limited, and is preferably 15 minutes or less, more preferably 10 minutes or less, even more preferably 7 minutes or less, and still even more preferably 5 minutes or less. When the leaving-to-stand time is too long, the maintenance liquid may enter the inside of a nozzle flow path to be mixed with the ink. However, being within the above leaving-to-stand time range or less can reduce or inhibit the mixing, which is preferable.

Note that the maintenance method according to the present embodiment may include, after the leaving-to-stand step, a wiping step (described below) of wiping the nozzle surface with the absorbing member used in the leaving-to-stand step. That is, the absorbing member can be used in both the leaving-to-stand step and the wiping step.

The wiping can be performed by, for example, moving the absorbing member 21 or the ink jet head 2 in the left-to-right direction in the figure in a state where the absorbing member 21 is in contact with the nozzle forming surface 222.

### 1.1.4 Maintenance Liquid

The components contained in the maintenance liquid are not particularly limited, and examples thereof include water, an organic solvent, a surfactant, and a neutralizer. Each component contained in the maintenance liquid will be described below.

### 1.1.4.1 Water

The maintenance liquid is preferably water-based. When the maintenance liquid is a water-based maintenance liquid, a solidified component of the water-based ink composition is easily redispersed, and the nozzle recoverability tends to be more excellent.

“Water-based” refers to that at least water is contained as a solvent component, and water may be contained as a main solvent component.

Examples of water include pure water such as ion exchanged water, ultrafiltration water, reverse osmosis water, and distilled water, and water having reduced ionic impurities such as ultrapure water. In addition, when water sterilized by ultraviolet irradiation, addition of hydrogen peroxide, or the like is used, the occurrence of bacteria or fungi can be inhibited when the maintenance liquid is stored for a long period of time.

The content of water is preferably 50% by mass or more, and more preferably 50 to 100% by mass in a liquid medium component. Furthermore, the content is preferably 60 to 95% by mass, more preferably 70 to 90% by mass, and even more preferably 75 to 85% by mass. Note that the liquid medium is a solvent component such as water or an organic solvent.

In addition, the content of water is preferably 40% by mass or more, preferably 50% by mass or more, more preferably 60% by mass or more, and even more preferably 70% by mass or more with respect to the total mass of the maintenance liquid. The upper limit of the content of water is not particularly limited, and is, for example, 100% by mass or less, preferably 99% by mass or less, and more preferably 90% by mass or less with respect to the total mass of the maintenance liquid.

### 1.1.4.2 Organic Solvent

The maintenance liquid may contain an organic solvent. The organic solvent is preferably a water-soluble organic solvent. The term “water-soluble” refers to that the water solubility at 20° C. is more than 10 g/100 g of water.

Examples of the organic solvent include esters, glycol ethers, cyclic esters, amides, alcohols, and polyhydric alcohols.

Examples of esters include glycol monoacetates such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate; and glycol diesters such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, diethylene glycol acetate butyrate, propylene glycol acetate propionate, propylene glycol acetate butyrate, dipropylene glycol acetate butyrate, and dipropylene glycol acetate propionate.

Examples of glycol ethers include monoethers and diethers of alkylene glycols.

Examples of monoethers of alkylene glycols include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, tripropylene glycol monobutyl ether, 3-methoxy-3-methylbutanol, and 3-methoxy-butanol.

Examples of diethers of alkylene glycols include alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Examples of cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and ε-decanolactone; and compounds in which the hydrogen atom of the methylene group adjacent to the carbonyl group thereof is replaced with an alkyl group having 1 to 4 carbon atoms.

Examples of amides include cyclic amides and acyclic amides. Examples of acyclic amides include alkoxyalkylamides.

Examples of cyclic amides include lactams. Examples of lactams include pyrrolidones such as 2-pyrrolidone, 1-methyl-2-pyrrolidone, 1-ethyl-2-pyrrolidone, 1-propyl-2-pyrrolidone, 1-butyl-2-pyrrolidone, and 1-(2-hydroxyethyl)pyrrolidin-2-one.

Examples of alkoxyalkylamides include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N, N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, 3-tert-butoxy-N,N-methylethylpropionamide, and N,N-dimethylisobutyramide.

Examples of alcohols include compounds in which one hydrogen atom of an alkane is replaced with a hydroxy group. The alkane preferably has 10 or less carbon atoms, more preferably 6 or less carbon atoms, and even more preferably 3 or less carbon atoms. The number of carbon atoms of the alkane is 1 or more, and is preferably 2 or more. The alkane may be a linear type or a branched type. Examples of alcohols include methanol, ethanol, n-propyl alcohol, iso-propyl alcohol, n-butanol, 2-butanol, tert-butanol, iso-butanol, n-pentanol, 2-pentanol, 3-pentanol, tert-pentanol, 2-phenoxy ethanol, benzyl alcohol, and phenoxy propanol.

Polyhydric alcohols have two or more hydroxy groups in the molecule. Examples of polyhydric alcohols include alkanediols and polyols.

Polyhydric alcohols have a hydrocarbon skeleton and two or more hydroxy groups in the molecule, and may have an ether-bonded oxygen atom. It is preferable not to have a structure other than these structures.

Examples of alkanediols include compounds in which an alkane is substituted with two hydroxy groups. Examples of alkanediols include a 1,2-alkanediol, which is a general term for compounds in which hydroxy groups substitute the 1-position and the 2-position of an alkane, and other alkanediols other than the 1,2-alkanediol. Among them, the 1,2-alkanediol is preferable.

The number of carbon atoms of alkanediols is preferably 2 or more, and more preferably 3 to 10. It is preferably 5 or more, and more preferably 5 to 8. On the other hand, it is also preferably 4 or less.

Examples of the 1,2-alkanediol include ethylene glycol, 1,2-propanediol (propylene glycol), 1,2-butanediol, 1,2-pentanediol (1,2PD) 1,2-hexanediol, 1,2-heptanediol, 1,2-octanediol, 1,2-nonanediol, 1,2-decanediol, 3-methyl-1,2-butanediol, 3-methyl-1,2-pentanediol, 4-methyl-1,2-pentanediol, 3,4-dimethyl-1,2-pentanediol, 3-ethyl-1,2-pentanediol, 4-ethyl-1,2-pentanediol, 3-methyl-1,2-hexanediol, 4-methyl-1,2-hexanediol, 5-methyl-1,2-hexanediol, 3,4-dimethyl-1,2-hexanediol, 3,5-dimethyl-1,2-hexanediol, 4,5-dimethyl-1,2-hexanediol, 3-ethyl-1,2-hexanediol, 4-ethyl-1,2-hexanediol, and 3-ethyl-4-methyl-1,2-hexanediol.

Examples of the other alkanediols include 1,3-propanediol, 1,3-butylene glycol (also known as 1,3-butanediol), 1,4-butanediol, 2,3-butanediol, 1,5-pentanediol, 2,4-pentanediol, 2-methyl-1,3-propanediol, 3-methyl-1,3-butanediol, 3-methyl-1,5-pentanediol, 2-ethyl-1,3-hexanediol, 2-methyl-1,3-pentanediol, 3-methyl-1,5-pentanediol, 2-methylpentane-2,4-diol, 1,6-hexanediol, 2-ethyl-2-methyl-1,3-propanediol, and 2-methyl-2-propyl-1,3-propanediol.

Examples of polyols include a condensate in which two or more molecules of alkanediols are intermolecularly condensed between hydroxy groups and a compound having three or more hydroxy groups.

Examples of the condensate in which two or more molecules of alkanediols are intermolecularly condensed between hydroxy groups include dialkylene glycols such as diethylene glycol and dipropylene glycol and trialkylene glycols such as triethylene glycol and tripropylene glycol.

The compound having three or more hydroxy groups is a compound having three or more hydroxy groups having an alkane or polyether structure as a skeleton. Examples of the compound having three or more hydroxy groups include glycerin, trimethylolethane, trimethylolpropane, 1,2,5-hexanetriol, 1,2,6-hexanetriol, pentaerythritol, and polyoxypropylenetriol.

One kind of the organic solvent may be used alone, or two or more kinds thereof may be used in combination.

Among these, a water-soluble organic solvent having a surface tension as a 20% aqueous solution at 25° C. of 30 mN/m or less is preferable. When the maintenance liquid contains such a water-soluble organic solvent, the nozzle recoverability tends to be more excellent. The surface tension as a 20% aqueous solution at 25° C. of the water-soluble organic solvent is more preferably 28 mN/m or less, and even more preferably 26 mN/m or less.

Examples of the water-soluble organic solvent having a surface tension as a 20% aqueous solution at 25° C. of 30 mN/m or less include 1,2-hexanediol (25.45 mN/m) and 3-methoxy-3-methylbutanol (29.66 mN/m).

The water-soluble organic solvent having a surface tension as a 20% aqueous solution at 25° C. of 30 mN/m or less is more preferably an alkanediol having 5 or more carbon atoms, and even more preferably 6 or more carbon atoms. When the alkanediol has 5 or more carbon atoms, the nozzle recoverability tends to be particularly excellent. The number of carbon atoms is preferably 10 or less.

Alternatively, the water-soluble organic solvent having a surface tension as a 20% aqueous solution at 25° C. of 30 mN/m or less is preferably glycol ethers. The number of carbon atoms of glycol ethers is preferably 3 to 10, more preferably 4 to 8, and even more preferably 5 to 7. The number of carbon atoms of the ether portion of glycol ethers is preferably 1 to 4, more preferably 1 to 3, and even more preferably 1 or 2. Glycol monoethers are preferable.

The content of the organic solvent is preferably 1% by mass or more, more preferably 5% by mass or more, even more preferably 10% by mass or more, and still even more preferably 15% by mass or more with respect to the total mass of the maintenance liquid.

On the other hand, the content of the organic solvent is preferably 30% by mass or less, more preferably 25% by mass or less, and even more preferably 20% by mass or less with respect to the total mass of the maintenance liquid.

The content of the water-soluble organic solvent having a surface tension as a 20% aqueous solution at 25° C. of 30 mN/m or less is preferably 1% by mass or more, more preferably 2% by mass or more, even more preferably 3% by mass or more, and still even more preferably 5% by mass or more with respect to the total mass of the maintenance liquid.

On the other hand, the content of the water-soluble organic solvent is preferably 15% by mass or less, more preferably 12% by mass or less, even more preferably 10% by mass or less, and particularly preferably 8% by mass or less with respect to the total mass of the maintenance liquid.

In particular, when the maintenance liquid contains the water-soluble organic solvent having a surface tension as a 20% aqueous solution at 25° C. of 30 mN/m or less in an amount of 3% by mass or more with respect to the total mass of the maintenance liquid, the nozzle recoverability tends to be more excellent.

### 1.1.4.3 Surfactant

The maintenance liquid may contain a surfactant. As the surfactant, any of a nonionic surfactant, an anionic surfactant, a cationic surfactant, and an amphoteric surfactant can be used, and these surfactants may be used in combination. Among the surfactants, an acetylene glycol-based surfactant, a silicone-based surfactant, and a fluorine-based surfactant can be more preferably used, and a silicone-based surfactant can be even more preferably used.

The acetylene glycol-based surfactant is not particularly limited, and for example, one or more selected from 2,4,7,9-tetramethyl-5-decyne-4,7-diol and an alkylene oxide adduct of 2,4,7,9-tetramethyl-5-decyne-4,7-diol, and 2,4-dimethyl-5-decyn-4-ol and an alkylene oxide adduct of 2,4-dimethyl-5-decyn-4-ol are preferable. Commercially available products of the acetylene glycol-based surfactant are not particularly limited, and examples thereof include Surfynol 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (all are trade names, manufactured by Air Products Japan, Inc.), Olfine B, Y, P, A, STG, SPC, E1004, E1010, PD-001, PD-002W, PD-003, PD-004, EXP.4001, EXP.4036, EXP.4051, AF-103, AF-104, AK-02, SK-14, and AE-3 (all are trade names, manufactured by Nissin Chemical Co., Ltd.), Acetylenol E00, E00P, E40, and E100 (all are trade names, manufactured by Kawaken Fine Chemicals Co., Ltd.). One kind of the acetylene glycol-based surfactant may be used alone, or two or more kinds thereof may be used in combination.

The silicone-based surfactant is not particularly limited, and examples thereof include a polysiloxane-based compound and a polyether-modified organosiloxane. Commercially available products of the silicone-based surfactant are not particularly limited, and examples thereof include BYK-306, BYK-307, BYK-333, BYK-341, BYK-345, BYK-346, BYK-348, and BYK 349 (trade names, manufactured by BYK Japan K.K.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF 6017 (trade names, manufactured by Shin-Etsu Chemical Co., Ltd.), and Silface SAG503A and Silface SAG014 (trade names, manufactured by Nissin Chemical Co., Ltd.). One kind of the silicone-based surfactant may be used alone, or two or more kinds thereof may be used in combination.

The fluorine-based surfactant is not particularly limited, and examples thereof include a perfluoroalkyl sulfonate, a perfluoroalkyl carboxylate, a perfluoroalkyl phosphonate, a perfluoroalkyl ethylene oxide adduct, a perfluoroalkyl betaine, and a perfluoroalkyl amine oxide compound. Commercially available products of the fluorine-based surfactant are not particularly limited, and examples thereof include S-144 and S-145 (trade names, manufactured by Asahi Glass Co., Ltd.); FC-170C, FC-430, and Fluorad FC4430 (trade names, manufactured by Sumitomo 3M Ltd.); FSO, FSO-100, FSN, FSN-100, and FS-300 (trade names, manufactured by Dupont); and FT-250 and 251 (trade names, manufactured by Neos Company Limited). One kind of the fluorine-based surfactant may be used alone, or two or more kinds thereof may be used in combination.

One kind of the surfactant may be used alone, or two or more kinds thereof may be used in combination. Among the exemplified surfactants, a surfactant that functions as a defoaming agent may be used. Examples of such a defoaming agent include Surfynol DF110D (trade name, manufactured by Air Products and Chemicals, Inc.).

Among these, the maintenance liquid preferably contains a surfactant having a surface tension as a 0.1% propylene glycol solution at 25° C. of 30 to 35 mN/m. When the surfactant is contained, the nozzle recoverability tends to be more excellent.

Examples of the surfactant having a surface tension as a 0.1% propylene glycol solution at 25° C. of 30 to 35 mN/m include BYK 348 (34. 68 mN/m) and BYK 349 (33. 86 mN/m) (trade names, manufactured by BYK Japan K.K.).

The content of the surfactant is preferably 5.0% by mass or less, more preferably 3.0% by mass or less, even more preferably 2.0% by mass or less, particularly preferably 1.5% by mass or less, and more particularly preferably 1.0% by mass or less with respect to the total mass of the maintenance liquid. In addition, the lower limit of the content of the surfactant is not particularly limited, and is preferably 0.01% by mass or more, more preferably 0.1% by mass or more, even more preferably 0.3% by mass or more, and still even more preferably 0.5% by mass or more with respect to the total mass of the maintenance liquid.

The content of the defoaming agent out of the surfactant is preferably 3.0% by mass or less, more preferably 2.0% by mass or less, even more preferably 1.0% by mass or less, particularly preferably 0.7% by mass or less, and more particularly preferably 0.5% by mass or less with respect to the total mass of the maintenance liquid. In addition, the lower limit of the content of the defoaming agent out of the surfactant is not particularly limited, and is preferably 0.01% by mass or more, more preferably 0.05% by mass or more, and even more preferably 0.1% by mass or more with respect to the total mass of the maintenance liquid.

It is also preferable that the content of the surfactant having a surface tension as a 0.1% propylene glycol solution at 25° C. of 30 to 35 mN/m be made the same as the content of the surfactant.

### 1.1.4.4 Neutralizer

The maintenance liquid may contain a neutralizer. The neutralizer is not particularly limited, and examples thereof include inorganic acids (e.g., sulfuric acid, hydrochloric acid, nitric acid, and the like), inorganic bases (e.g., lithium hydroxide, sodium hydroxide, potassium hydroxide, ammonia, and the like), organic bases (triethanolamine, diethanolamine, monoethanolamine, and triisopropanolamine), and organic acids (e.g., adipic acid, citric acid, succinic acid, and the like). Among these, organic bases are preferable, and triethanolamine (TEA) and triisopropanolamine are more preferable.

The content of the neutralizer is preferably 3.0% by mass or less, more preferably 2.0% by mass or less, even more preferably 1.0% by mass or less, particularly preferably 0.7% by mass or less, and more particularly preferably 0.5% by mass or less with respect to the total mass of the maintenance liquid. In addition, the lower limit of the content of the neutralizer is not particularly limited, and is preferably 0.01% by mass or more, more preferably 0.05% by mass or more, and even more preferably 0.1% by mass or more with respect to the total mass of the maintenance liquid.

### 1.1.4.5 Other Components

The maintenance liquid may contain additives such as a preservative, a fungicide, a rust inhibitor, a viscosity modifier, a dissolution aid, and an antioxidant as needed. When such an additive is contained, the content thereof is preferably 0.1 to 5% by mass, more preferably 0.1 to 3% by mass, and even more preferably 0.1 to 1% by mass with respect to the total mass of the maintenance liquid.

### 1.2 Suction Step

The maintenance method according to the present embodiment may include, after the above-described leaving-to-stand step, a suction step of sucking liquid such as ink from the nozzle of the ink jet head. When the suction step is included, the nozzle recoverability tends to be more excellent.

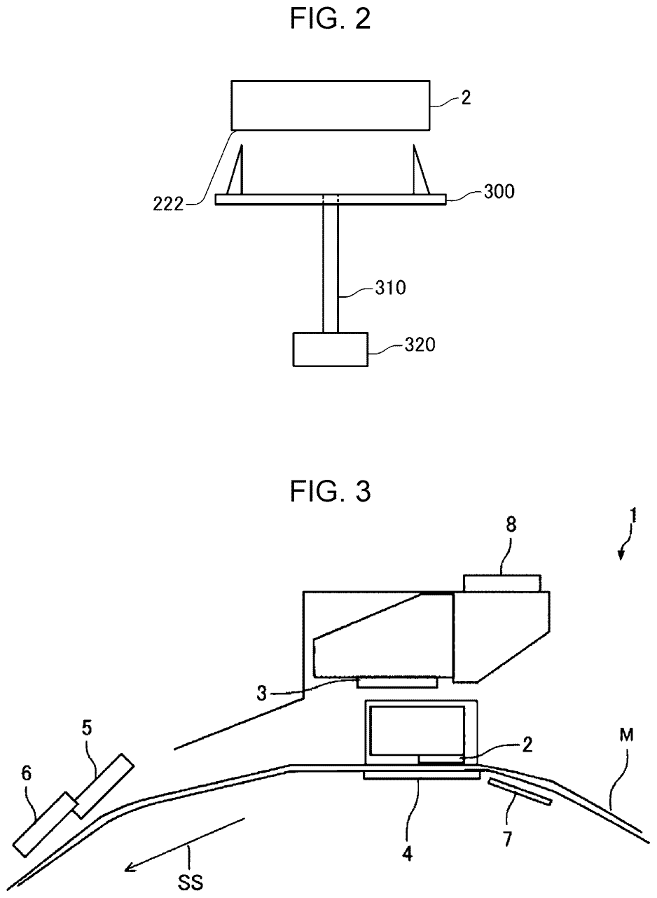

FIG. 2 shows a schematic cross-sectional view representing a state in which liquid such as ink is sucked from the nozzle of the ink jet head using a suction mechanism. The suction mechanism includes a cap device 300, a suction tube 310, and a suction device 320.

The cap device 300 is disposed so as to cover the nozzle forming surface 222 of the ink jet head 2, and receives the ink discharged from the ink jet head 2 in the suction step.

The suction device 320 is connected to the cap device 300 via the suction tube 310, and is a device for performing the suction step of sucking and removing the ink and the like inside the ink jet head 2. The suction device 320 can forcibly eject the ink and the like remaining inside the ink jet head 2 by setting the inside of the cap device 300 to a negative pressure.

### 1.3 Wiping Step

The maintenance method according to the present embodiment may include, after the above-described leaving-to-stand step, a wiping step of wiping the nozzle surface in which the nozzle of the ink jet head is formed with the absorbing member containing the maintenance liquid. When the wiping step is included, the nozzle recoverability tends to be more excellent.

The wiping method is not particularly limited, and for example, wiping can be performed while moving the absorbing member or the nozzle surface such that the absorbing member is pressed against the nozzle surface and the absorbing member is relatively moved in a direction along the nozzle surface.

The wiping direction is not particularly limited, but wiping is preferably performed in a direction along a nozzle row. This can avoid the nozzle surface from being contrarily contaminated due to a portion of the absorbing member that has come into contact with one nozzle row coming into contact with another nozzle row.

The pressing load of the absorbing member against the nozzle forming surface in the wiping step can be the same as the pressing load in the above-described leaving-to-stand step.

### 1.4 Application Target

The maintenance method according to the present embodiment is a maintenance method for a recording apparatus including an ink jet head having a nozzle that ejects a water-based ink composition.

### 1.4.1 Ink Composition

The components contained in the ink composition are not particularly limited, and examples thereof include water, a coloring material, a fixing resin, a surfactant, and an organic solvent. The ink composition is preferably an ink jet ink composition for use in an ink jet method. Each component contained in the ink composition will be described below.

### 1.4.1.1 Water

The ink composition is a water-based composition and contains water. The configuration about the kind, content, and the like of water in the ink composition can be the same as those of the above-described maintenance liquid.

### 1.4.1.2 Coloring Material

The ink composition may contain a coloring material. Examples of the color material include a dye and a pigment.

As the pigment, for example, an inorganic pigment including carbon black and titanium white, an organic pigment, and the like can be used.

As the inorganic pigment, carbon blacks such as C.I. Pigment Black 6 (lamp black, vegetable black), C.I. Pigment Black 7 (furnace black, channel black, thermal black, acetylene black), C.I. Pigment Black 8 (charcoal black), and C.I. Pigment Black 10 (graphite), iron oxide, titanium oxide, zinc oxide, silica, and the like can be used.

Examples of carbon blacks include No. 2300, 900, MCF88, No. 20B, No. 33, No. 40, No. 45, No. 52, MA7, MA8, MA100, and No. 2200B manufactured by Mitsubishi Chemical Corporation. Examples include Color Black FW1, FW2, FW2V, FW18, FW200, S150, S160, and S170, Pretex 35, U, V, and 140U, and Special Black 6, 5, 4A, 4, and 250 manufactured by Degussa Corporation. Examples include Conductex SC, and Raven 1255, 5750, 5250, 5000, 3500, 1255, and 700 manufactured by Columbia Carbon Company. Examples include Regal 400R, 330R, and 660R, Mogul L, Monarch 700, 800, 880, 900, 1000, 1100, 1300, and 1400, and Elftex 12 manufactured by Cabot Corporation.

As a white pigment, examples include metal compounds such as a metal oxide, barium sulfate, and calcium carbonate. Examples of the metal oxide include titanium dioxide, zinc oxide, silica, alumina, and magnesium oxide. In addition, particles having a hollow structure may be used for the white pigment.

Examples of the organic pigment include a quinacridone-based pigment, a quinacridone quinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzimidazolone-based pigment, an isoindolinone-based pigment, an azomethine-based pigment, and an azo-based pigment. Specific examples of the organic pigment include the following ones.

As a cyan pigment, examples include C.I. Pigment Blue 1, 2, 3, 15:3, 15:4, 15:34, 16, 22, and 60; and C.I. Vat Blue 4 and 60, and preferable examples include one or a mixture of two or more selected from the group consisting of C.I. Pigment Blue 15:3, 15:4, and 60.

As a magenta pigment, examples include C.I. Pigment Red 5, 7, 12, 48(Ca), 48(Mn), 57(Ca), 57:1, 112, 122, 123, 168, 184, and 202; and C.I. Pigment Violet 19, and preferable examples include one or a mixture of two or more selected from the group consisting of C.I. Pigment Red 122, 202, and 209, and C.I. Pigment Violet 19. Solid solutions of the pigment may be used.

As a yellow pigment, examples include C.I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, and 185, and preferable examples include one or a mixture of two or more selected from the group consisting of C.I. Pigment Yellow 74, 109, 110, 128, 138, 155, and 180.

As an orange pigment, examples include C.I. Pigment Orange 36 or 43 or a mixture thereof. As a green pigment, examples include C.I. Pigment Green 7 or 36 or a mixture thereof.

In addition, a bright pigment may be used; the pigment is not particularly limited so long as it is capable of exhibiting brightness when attached to a medium, and examples thereof include metal particles of one or two or more alloys (also referred to as a metal pigment) selected from the group consisting of aluminum, silver, gold, platinum, nickel, chromium, tin, zinc, indium, titanium, and copper, and a pearl pigment having pearl gloss. Representative examples of the pearl pigment include a pigment having pearl gloss or interference gloss, such as titanium dioxide-coated mica, fish scale foil, and bismuth oxychloride. In addition, the bright pigment may be subjected to a surface treatment for inhibiting a reaction with water.

One kind of the pigment may be used alone, or two or more kinds thereof may be used in combination. The pigment is preferably an organic pigment from the viewpoint of storage stability such as light resistance, weather resistance, and gas resistance.

For the volume average particle diameter (D50) of the pigment, a volume average particle diameter (D50) when measured by a dynamic light scattering method is 20 nm or more and 300 nm or less, the volume average particle diameter (D50) is more preferably 30 nm or more and 200 nm or less, and the volume average particle diameter (D50) is further more preferably 40 nm or more and 100 nm or less.

The measurement of the volume average particle diameter may be performed by using, for example, a Nanotrac series particle diameter distribution measurement device manufactured by MicrotracBEL Corp. In addition, examples of a method of adjusting the volume average particle diameter include a method of adjusting a volume average particle diameter by adjusting a degree of pulverization of a pigment before dispersion, a method of adjusting a volume average particle diameter by adjusting stirring conditions (for example, stirring speed, stirring temperature, and the like) during dispersion, and a method of adjusting a volume average particle diameter by filtration using a filter after dispersion.

In order to enhance dispersibility in the ink composition, the pigment is preferably subjected to a surface treatment or formulated with a dispersant or the like.

The surface treatment of the pigment is preferably a treatment to directly or indirectly bond a carbonyl group, a carboxy group, an aldehyde group, a hydroxy group, a sulfone group, an ammonium group, a functional group formed of salts thereof, or the like to the surface of the pigment by physical or chemical treatment. In particular, the surface treatment is more preferably a surface treatment to modify surfaces of pigment particles such that the surface of the pigment is oxidized or sulfonated with, for example, ozone, hypochlorous acid, fuming sulfuric acid, or the like.

When the dispersant is used, a dispersant having a hydrophobic portion (hydrophobic group) and a hydrophilic portion (hydrophilic group) in the molecular structure is preferable. Such a dispersant has an action to cause the hydrophobic portion to be adsorbed to a particle surface of the pigment and the hydrophilic portion to be oriented to an aqueous medium side of the ink composition. This action is likely to enable the pigment to be more stably contained in the ink composition as a dispersion.

Such a dispersant is not particularly limited, and examples thereof include an acrylic resin, a styrene-acrylic resin such as a styrene-(meth)acrylic acid copolymer and a styrene-(meth)acrylic acid-(meth)acrylate copolymer, a styrene-maleic acid-based resin, salts thereof, and formalin condensates of aromatic sulfonates, and one or more selected from these groups can be adopted. Note that a commercially available product may be used as the dispersant.

When the pigment is dispersed by the dispersant, the ratio of the pigment to the dispersant is preferably 10:1 to 1:10, and more preferably 4:1 to 1:3.

In addition, a method of coating particles of the pigment with a resin or the like to impart dispersibility may be used. As the method of coating the pigment particles, an acid precipitation method, a phase inversion emulsification method, a mini-emulsion polymerization method, and the like can be adopted.

The content of the coloring material is preferably 30% by mass or less, more preferably 20% by mass or less, and even more preferably 10% by mass or less with respect to the total mass of the ink composition. When the content of the coloring material is within the above range, the resolubility or redispersibility at the time of being made into the ink composition tends to be more excellent.

The lower limit of the content of the coloring material is not particularly limited, and is preferably 0.1% by mass or more, more preferably 1% by mass or more, even more preferably 3% by mass or more, and particularly preferably 5% by mass or more with respect to the total mass of the ink composition.

### 1.4.1.3 Fixing Resin

The ink composition may contain a fixing resin. The fixing resin has, for example, a function of improving the adhesion and abrasion resistance of the ink component, and a function of smoothing the surface of a recording medium or the surface of an ink coating film. On the other hand, when the fixing resin is contained, there is a tendency that the ink component is, for example, solidified in the vicinity of the nozzle, and the nozzle is easily clogged, but according to the maintenance method of the present embodiment, even when the fixing resin is contained in the ink composition, there is a tendency that excellent nozzle recoverability can be obtained.

The form of the fixing resin may be a water-soluble resin, but is preferably resin particles. The resin particles are often handled in emulsion form, but may be in powder form. The fixing resin can be contained by being dispersed or dissolved in the solvent component of the ink.

Examples of the fixing resin include a urethane-based resin, an acrylic resin (including a styrene-acrylic resin), a fluorene-based resin, a polyolefin-based resin, a rosin-modified resin, a terpene-based resin, a polyester-based resin, a polyamide-based resin, an epoxy-based resin, a vinyl chloride-based resin, a vinyl chloride-vinyl acetate copolymer, and an ethylene-vinyl acetate-based resin. Among these, a urethane-based resin, an acrylic resin, a polyolefin-based resin, and a polyester-based resin are preferable.

The urethane-based resin is a general term for resins having a urethane bond. For the urethane-based resin, a polyether-type urethane resin including an ether bond in the main chain, a polyester-type urethane resin including an ester bond in the main chain, and a polycarbonate-type urethane resin including a carbonate bond in the main chain, in addition to the urethane bond, and the like may be used. In addition, as the urethane-based resin, commercially available products may be used. For example, commercially available products such as Superflex 460, 460s, 840, and E-4000 (trade names, manufactured by DKS Co., Ltd.), Resamine D-1060, D-2020, D-4080, D-4200, D-6300, and D-6455 (trade names, manufactured by Dainichiseika Color & Chemicals Mfg. Co., Ltd.), Takelac WS-6021 and W-512-A-6 (trade names, manufactured by Mitsui Chemicals Polyurethanes, Inc.), Sancure 2710 (trade name, manufactured by LUBRIZOL), and Permarin UA-150 (trade name, manufactured by Sanyo Chemical Industries Ltd.) may be used.

The acrylic resin is a general term for polymers obtained by polymerizing at least an acrylic monomer such as (meth)acrylic acid and (meth)acrylate as one component, and examples thereof include a resin obtained from an acrylic monomer, and a copolymer of an acrylic monomer and a monomer other than the acrylic monomer. Examples thereof include an acrylic-vinyl-based resin, which is a copolymer of an acrylic monomer and a vinyl-based monomer. In addition, examples of the vinyl-based monomer include styrene.

As the acrylic monomer, acrylamide, acrylonitrile, and the like can also be used. As a resin emulsion using the acrylic resin as a raw material, commercially available products may be used, and for example, the resin emulsion selected from FK-854 (trade name, manufactured by Chuo Rika Kogyo Corporation), Mowinyl 6969D, 6899D, 952B, and 718A (trade names, manufactured by The Nippon Synthetic Chemical Industry Co., Ltd.), Nipol LX852 and LX874 (trade names, manufactured by Zeon Corporation), and the like may be used.

Incidentally, in the present specification, the acrylic resin may be a styrene-acrylic resin described later.

The styrene-acrylic resin is a copolymer obtained from a styrene monomer and a (meth)acrylic monomer, and examples thereof include a styrene-acrylic acid copolymer, a styrene-methacrylic acid copolymer, a styrene-methacrylic acid-acrylate copolymer, a styrene-α-methylstyrene-acrylic acid copolymer, and a styrene-α-methylstyrene-acrylic acid-acrylate copolymer. As the styrene-acrylic resin, commercially available products may be used, and for example, Joncryl 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (trade names, manufactured by BASF SE), Mowinyl 966A and 975N (trade names, manufactured by The Nippon Synthetic Chemical Industry Co., Ltd.), Vinyblan 2586 (manufactured by Nissin Chemical Industry Co., Ltd.), and the like may be used.

The polyolefin-based resin has an olefin such as ethylene, propylene, and butylene in the structural skeleton, and known ones can be appropriately selected and used. As the olefin resin, commercially available products can be used, and for example, Arrowbase CB-1200 and CD-1200 (trade names, manufactured by Unitika Ltd.), and the like may be used.

Further, the fixing resin may be supplied in the form of an emulsion, and as examples of commercially available products of such resin emulsions, Microgel E-1002 and E-5002 (trade names, manufactured by Nippon Paint Co., Ltd., styrene-acrylic resin emulsion), Voncoat 4001 (trade name, manufactured by DIC Corporation, acrylic resin emulsion), Voncoat 5454 (trade name, manufactured by DIC Corporation, styrene-acrylic resin emulsion), Polysol AM-710, AM-920, AM-2300, AP-4735, AT-860, and PSASE-4210E (acrylic resin emulsion), Polysol AP-7020 (styrene-acrylic resin emulsion), Polysol SH-502 (vinyl acetate resin emulsion), Polysol AD-13, AD-2, AD-10, AD-96, AD-17, and AD-70 (ethylene-vinyl acetate resin emulsion), Polysol PSASE-6010 (ethylene-vinyl acetate resin emulsion) (trade names, manufactured by Showa Denko K.K.), Polysol SAE1014 (trade name, styrene-acrylic resin emulsion, manufactured by Zeon Corporation), Saibinol SK-200 (trade name, acrylic resin emulsion, manufactured by Saiden Chemical Industry Co., Ltd.), AE-120A (trade name, manufactured by JSR Corporation, acrylic resin emulsion), AE373D (trade name, manufactured by Emulsion Technology Co., Ltd., carboxy-modified styrene-acrylic resin emulsion), Seikadyne 1900W (trade name, manufactured by Dainichiseika Color & Chemicals Mfg. Co., Ltd., ethylene-vinyl acetate resin emulsion), Vinyblan 2682 (acrylic resin emulsion), Vinyblan 2886 (vinyl acetate-acrylic resin emulsion), Vinyblan 5202 (acrylic acetate resin emulsion) (trade names, manufactured by Nissin Chemical Industry Co., Ltd.), Elitel KA-5071S, KT-8803, KT-9204, KT-8701, KT-8904, and KT-0507 (trade names, manufactured by Unitika LTD., polyester resin emulsion), Hytec SN-2002 (trade name, manufactured by Toho Chemical Industry Co., Ltd., polyester resin emulsion), Takelac W-6020, W-635, W-6061, W-605, W-635, and W-6021 (trade names, manufactured by Mitsui Chemicals Polyurethanes, Inc., urethane-based resin emulsion), Superflex 870, 800, 150, 420, 460, 470, 610, and 700 (trade names, manufactured by DKS Co., Ltd., urethane-based resin emulsion), Permarin UA-150 (manufactured by Sanyo Chemical Industries, Ltd., urethane-based resin emulsion), Sancure 2710 (manufactured by The Lubrizol Corporation, Japan, urethane-based resin emulsion), NeoRez R-9660, R-9637, and R-940 (manufactured by Kusumoto Chemicals, Ltd., urethane-based resin emulsion), Adeka Bontighter HUX-380 and 290K (manufactured by Adeka Corporation, urethane-based resin emulsion), Mowinyl 966A and Mowinyl 7320 (manufactured by The Nippon Synthetic Chemical Industry Co., Ltd.), Joncryl 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (manufactured by BASF SE), NK Binder R-5HN (manufactured by Shin-Nakamura Chemical Co., Ltd.), Hydran WLS-210 (non-crosslinked polyurethane: manufactured by DIC Corporation), Joncryl 7610 (manufactured by BASF SE), or the like may be selected and used.

The content of the fixing resin in the ink composition is preferably 0.5% by mass or more, more preferably 1.0% by mass or more, even more preferably 1.5% by mass or more, and particularly preferably 2.0% by mass or more with respect to the total mass of the ink composition from the viewpoint of a tendency to be more excellent in abrasion resistance.

In addition, the content of the fixing resin in the ink composition is preferably 15.0% by mass or less, more preferably 10% by mass or less, even more preferably 8.0% by mass or less, and still even more preferably 5.0% by mass or less with respect to the total mass of the ink composition from the viewpoint of a tendency to be more excellent in ejection stability.

### 1.4.1.4 Surfactant

The ink composition may contain a surfactant. The configuration about the kind, content, and the like of the surfactant in the ink composition can be the same as those of the above-described maintenance liquid.

### 1.4.1.5 Organic Solvent

The ink composition may contain an organic solvent. The type, content, and the like of the organic solvent in the ink composition can be the same as those of the above-described maintenance liquid.

As the organic solvent, the ink composition preferably contains an alkanediol, more preferably contains a 1,2-alkanediol, and even more preferably contains a 1,2-alkanediol having 5 or less carbon atoms.

The content thereof is preferably the same as the content of the organic solvent in the above-described maintenance liquid.

In the ink composition, the content of a polyol having a standard boiling point of 250° C. or higher as an organic solvent is preferably 5% by mass or less, more preferably 3% by mass or less, even more preferably 1% by mass or less, particularly preferably 0.1% by mass or less, and more particularly preferably 0% by mass (not contained) with respect to the total mass of the ink composition. When the content of the polyol having a standard boiling point of 250° C. or higher is within the above range, the abrasion resistance of a recorded matter tends to be further improved. Examples of the polyol having a standard boiling point of 250° C. or higher include glycerin and triethylene glycol.

Furthermore, the content of a polyhydric alcohol having a standard boiling point of 250° C. or higher as an organic solvent in the ink may be set to the above range, which is preferable. Furthermore, the content of the organic solvent in the ink may be set to the above range, which is preferable.

### 1.4.1.6 Other Components

The ink composition may contain various additives such as a wax, a chelating agent, a rust inhibitor, an antifungal agent, an antioxidant, an anti-reducing agent, and an evaporation accelerator as needed. When such an additive is contained, the content thereof is preferably 0.1 to 5% by mass, more preferably 0.1 to 3% by mass, and even more preferably 0.1 to 1% by mass with respect to the total mass of the ink composition.

### 1.4.2 Recording Apparatus

A recording apparatus to which the maintenance method according to the present embodiment can be suitably applied will be described below.

### 1.4.2.1 Recording Medium

The recording apparatus may be an apparatus that ejects the above-described ink composition from the nozzle to perform recording on a low-absorbent recording medium or a non-absorbent recording medium. A water-based ink composition for use in the case of performing recording on such a recording medium can contain a component such as a fixing resin and is likely to be inferior in nozzle recoverability, but with the maintenance method according to the present embodiment, there is a tendency that excellent nozzle recoverability can be obtained.

The term low-absorbent recording medium or non-absorbent recording medium refers to a recording medium having a property of not absorbing liquid at all or hardly absorbing liquid. Quantitatively, the low-absorbent recording medium or non-absorbent recording medium refers to “a recording medium in which a water absorption amount from the start of contact to 30 msec^{1/2} in the Bristow method is 10 mL/m² or less.” The Bristow method is the most popular method for measuring a liquid absorption amount in a short time and is also adopted by Japan Technical Association of the Pulp and Paper Industry (JAPAN TAPPI). Details of the test method are described in Standard No. 51 “Paper and Paperboard-Liquid Absorptivity Test Method-Bristow Method” of “JAPAN TAPPI Paper and Pulp Test Method 2000 Edition.” On the other hand, the absorbent recording medium refers to a recording medium corresponding to neither the low-absorbent recording medium nor the non-absorbent recording medium.

Examples of the low-absorbent recording medium include a recording medium having a low-absorbent coating layer provided on the surface thereof, which is referred to as coated paper. Examples of the recording medium whose base material is paper include printed paper such as art paper, coated paper, and matte paper. When the base material is a plastic film, examples thereof include recording media in which a polymer or the like is applied onto the surface of polyvinyl chloride, polyethylene terephthalate, polycarbonate, polystyrene, polyurethane, polyethylene, polypropylene, or the like, and recording media in which particles of silica, titanium, or the like are applied together with a binder.

Examples of the non-absorbent recording medium include recording media in which plastic is applied onto a base material such as paper, recording media in which a plastic film is bonded to a base material such as paper, and plastic films without an absorbing layer (receiving layer). Examples of the plastic include polyvinyl chloride, polyethylene terephthalate, polycarbonate, polystyrene, polyurethane, polyethylene, and polypropylene.

### 1.4.2.2 Recording Method

### Ink Attaching Step

The recording performed by the recording apparatus may include an ink attaching step of ejecting the above-described ink composition from an ink jet head and attaching the ink composition to a recording medium.

The attachment amount of the ink composition is preferably 2.0 to 20 mg/inch², more preferably 3.0 to 10 mg/inch², and even more preferably 6.0 to 8.0 mg/inch². In addition, it is also preferable that the recording medium include a region of the above attachment amount range, and it is also preferable that the maximum attachment amount range of the ink composition in recording be the above attachment amount range or less.

### Primary Drying Step

The recording performed by the recording apparatus may include a drying step (a primary drying step) of drying the recording medium in the ink attaching step. By including such a drying step, the ink can be dried at an early stage, and there is a tendency that the abrasion resistance and the image quality can be further improved.

The primary drying step is a step of performing heating, air blowing, or the like on the recording medium to dry the ink at an early stage. The primary drying step is a step of drying at least part of the solvent component of the ink to such an extent that at least the fluidity of the ink that has been attached to the recording medium is reduced. The primary drying step may be performed such that the ink is attached to the heated recording medium, or may be performed at an early stage after the attachment to promote drying.

In the primary drying step, it is preferable that ink droplets that have landed on the recording medium be started to be dried within 0.5 second at the latest from the landing. The drying unit (drying mechanism) for drying the ink on the recording medium is not particularly limited, and examples thereof include a platen heater, a hot air heater, and an IR heater, which include a heating function, and a blower, which does not include a heating function.

Examples of the type of the drying mechanism include a conduction type that conducts heat from a member in contact with the recording medium to the recording medium to heat the recording medium, a radiation type that radiates radiation such as IR to the recording medium to heat the recording medium, and an air blowing type that blows air toward the recording medium.

Examples of the air blowing type (an air blowing step) include a method in which the recording medium is heated while being blown with warm air, and a method in which drying of the ink is promoted by normal temperature air that does not involve heating. The method that does not involve heating is preferable in that it can inhibit ejection stability from decreasing due to drying of the ink in the nozzle of the ink jet head. It is also preferable to use any one of the conduction type and the radiation type, and the air blowing type in combination. When used in combination, the air blowing type may be a method that does not involve heating, which is preferable.

In the ink attaching step, the surface temperature of the portion of the recording medium facing the ink jet head is preferably 60° C. or lower, and more preferably 55° C. or lower. Furthermore, the temperature is preferably 50° C. or lower, and more preferably 45° C. or lower. Furthermore, the temperature is preferably 40° C. or lower, preferably 35° C. or lower, preferably 30° C. or lower, and preferably 27° C. or lower.

On the other hand, the temperature is preferably 20° C. or higher, more preferably 25° C. or higher, even more preferably 30° C. or higher, particularly preferably 35° C. or higher, and more particularly preferably 40° C. or higher. Furthermore, the temperature is preferably 30 to 60° C., and more preferably 35 to 55° C. The temperature is even more preferably 40 to 50° C.

When the surface temperature of the recording medium is within the above range or higher, drying properties are further improved, and the abrasion resistance of the obtained recorded matter tends to be further improved. In addition, when the temperature is within the above range or lower, clogging recoverability, ejection stability, and color developing properties are more excellent, which is preferable.

Note that the primary drying step may not be performed, or a step involving heating may not be performed as the primary drying step. In this case, it is easy to set the surface temperature of the recording medium especially on the platen to be within the above range or lower, which is preferable. On the other hand, when the primary drying step involving heating is performed, it is easy to set the surface temperature of the recording medium on the platen to be within the above range or higher, which is preferable.

In addition, when the air blowing type is used (the air blowing step is included in the ink attaching step), the air velocity in the vicinity of the recording medium is preferably 0.2 m/s or more, more preferably 0.5 m/s or more, even more preferably 1.0 m/s or more, particularly preferably 1.5 m/s or more, and more particularly preferably 2.0 m/s or more. Furthermore, the air velocity is preferably 4.0 m/s or more, particularly preferably 5 m/s or more, and more particularly preferably 7.0 m/s or more.

On the other hand, the air velocity is preferably 20 m/s or less, more preferably 15 m/s or less, even more preferably 13 m/s or less, and particularly preferably 12 m/s or less.

Furthermore, the air velocity is preferably 0.5 to 10 m/s, more preferably 1 to 4 m/s, and even more preferably 2 to 3 m/s.

The air temperature is preferably 45° C. or lower, more preferably 40° C. or lower, even more preferably 32° C. or lower, more preferably 30° C. or lower, even more preferably 27° C. or lower, and more preferably 25° C. or lower. On the other hand, the air temperature is preferably 20° C. or higher, and more preferably 23° C. or higher.

The air velocity and the air temperature are those in the vicinity of a recording surface of the recording medium on the platen.

### Secondary Drying Step

The recording performed by the recording apparatus may include a heating step (a secondary heating step) of heating the recording medium to which the ink composition has been attached. The secondary heating step is a step of heating sufficiently to the extent that the recording is completed and the recorded matter can be used. The secondary heating step is a step of sufficiently drying the solvent component of the ink and heating the fixing resin and the like contained in the ink to flatten the coating film of the ink.

The secondary heating step is preferably started greater than 0.5 second after the ink is attached to the recording medium. For example, it is preferable that greater than 0.5 second after the attachment of the ink to a certain recording area of the recording medium is all completed, heating of the area be started.

The surface temperature of the recording medium in the secondary heating step is preferably 50° C. or higher, more preferably 60° C. or higher, and even more preferably 70° C. or higher. In the secondary heating step, in particular, when the recording medium is heated at a surface temperature of 60° C. or higher, drying properties are excellent, and wet abrasion resistance tends to be better. The upper limit of the temperature is preferably 100° C. or lower, and more preferably 90° C. or lower.

Note that as a secondary heating mechanism, a conduction type, a radiation type, an air blowing type, or the like can be used.

### 2. Recording Apparatus

A recording apparatus according to an embodiment of the present disclosure is a recording apparatus that performs maintenance by the above-described maintenance method, and includes the above-described ink jet head, the above-described absorbing member, and the above-described maintenance liquid.

With the recording apparatus according to the present embodiment, maintenance is performed by the above-described maintenance method, and excellent nozzle recoverability can be obtained.

The recording apparatus according to the present embodiment will be described below with reference to the drawings.

FIG. 3 is a schematic cross-sectional view schematically showing an ink jet recording apparatus 1.

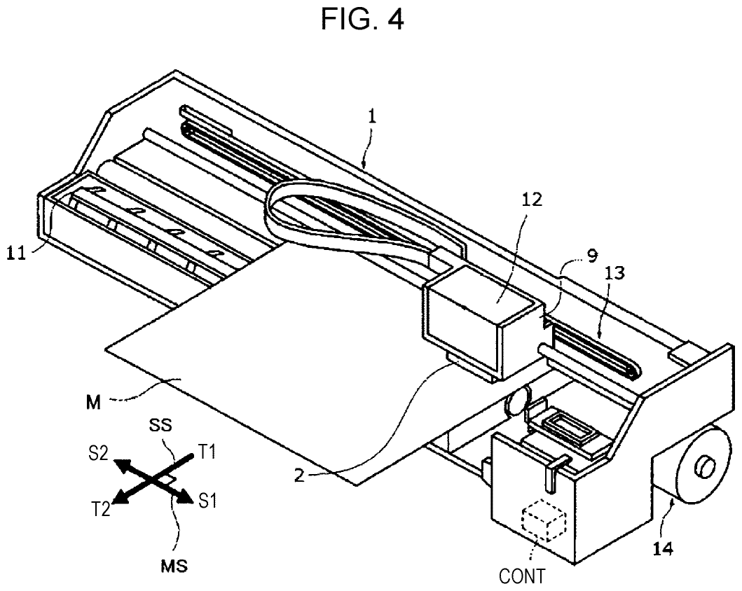

FIG. 4 is a perspective view showing an example of a configuration around a carriage of the ink jet recording apparatus 1 in FIG. 3.

FIGS. 1 and 2 are schematic cross-sectional views showing an example of the configuration about maintenance of the area around an ink jet head of the ink jet recording apparatus 1 in FIG. 3.

As illustrated in FIGS. 3 and 4, the ink jet recording apparatus 1 includes the ink jet head 2, the absorbing member 21, an IR heater 3, a platen heater 4, a heater 5, a cooling fan 6, a preheater 7, a ventilation fan 8, a carriage 9, a platen 11, a carriage moving mechanism 13, a transport unit 14, and a controller CONT. In the ink jet recording apparatus 1, the operation of the entire ink jet recording apparatus 1 is controlled by the controller CONT shown in FIG. 4.

The ink jet head 2 is an ink jet head having a nozzle that ejects the above-described ink composition, and it is possible to perform recording on a recording medium M by ejecting the ink composition from the nozzle of the ink jet head and attaching the ink composition.

By using the mechanism having the absorbing member 21 containing the maintenance liquid 31 as shown in FIG. 1, it is possible to perform the leaving-to-stand step and the wiping step described above on the nozzle forming surface 222 of the ink jet head 2.

In addition, by using the suction mechanism including the cap device 300, the suction tube 310, and the suction device 320 as shown in FIG. 2, it is possible to perform the above-described suction step in which the ink and the like is forcibly ejected from the nozzle of the ink jet head 2.

In the present embodiment, the ink jet head 2 is a serial type ink jet head, and is scanned once or a plurality of times in a main scanning direction relative to the recording medium M to attach the above-described ink composition to the recording medium M. The ink jet head 2 is mounted on the carriage 9 shown in FIG. 4. The ink jet head 2 is scanned once or a plurality of times in the main scanning direction relative to the recording medium M by an operation of the carriage moving mechanism 13 that moves the carriage 9 in a medium width direction of the recording medium M. The medium width direction is the main scanning direction of the ink jet head 2. Scanning in the main scanning direction is also referred to as main scanning.

In addition, here, the main scanning direction is a direction in which the carriage 9 on which the ink jet head 2 is mounted moves. In FIG. 3, the main scanning direction is a direction intersecting a sub-scanning direction, which is a transport direction of the recording medium M indicated by the arrow SS. In FIG. 4, the width direction of the recording medium M, that is, the direction represented by S1↔S2 is a main scanning direction MS, and the direction represented by T1→T2 is a sub-scanning direction SS. Note that scanning is performed in the main scanning direction, that is, in either one direction of the arrow S1 or the arrow S2 in one scan.

The cartridge 12 that supplies the ink to the ink jet head 2 includes a plurality of independent cartridges. The cartridge 12 is detachably mounted on the carriage 9 on which the ink jet head 2 is mounted. Each of the cartridges can be filled with a different type of ink, and the ink is supplied from the cartridge 12 to each nozzle. Note that the present embodiment shows an example in which the cartridge 12 is mounted on the carriage 9, but this is not limiting, and it may be provided at a location other than the carriage 9, and the ink may be supplied to each nozzle through a supply pipe, not shown.

A known system can be used for the ejection by the ink jet head 2. In the present embodiment, a method of ejecting droplets by using the vibration of a piezoelectric element, that is, an ejection method of forming ink droplets by mechanical deformation of an electrostrictive element is used.

The ink jet recording apparatus 1 includes the ventilation fan 8, the IR heater 3, and the platen heater 4 for drying the ink ejected from the ink jet head 2 and attached to the recording medium M. The primary drying step can be performed by using the ventilation fan 8, the IR heater 3, and the platen heater 4 in combination as appropriate. In the primary drying step, it is not always necessary to heat the recording medium M, and the ventilation fan 8 may be used alone for performing normal temperature air blowing.

Note that when the IR heater 3 is used, the recording medium M can be heated on the radiation type by the radiation of infrared rays from the side closer to the ink jet head 2. With this, the ink jet head 2 is also likely to be heated at the same time, but the temperature can be raised without being affected by the thickness of the recording medium M compared to a case in which heating is performed from the back of the recording medium M as in the platen heater 4 or the like. In addition, various fans (for example, the ventilation fan 8) may be provided for drying the ink on the recording medium M by blowing warm air or air having the same temperature as the environment against the recording medium M.

The platen heater 4 can heat the recording medium M at a position facing the ink jet head 2 through the platen 11 so that the ink ejected by the ink jet head 2 can be dried early from a time when being attached to the recording medium M. The platen heater 4 can heat the recording medium the M on the conduction type, and the ink can be attached to the recording medium M heated in this manner.

The surface temperature of the recording medium M due to the heating by the IR heater 3 and the platen heater 4 is preferably in the range described in the above-described primary drying step.

The heater 5 is a heater for drying and solidifying the ink attached to the recording medium M, that is, a heater for secondary drying. The heater 5 can be used in the secondary drying step. The heater 5 heats the recording medium M on which an image is recorded, so that moisture and the like contained in the ink are evaporated and scattered more quickly, and an ink film is formed by the resin particles that can be contained in the ink. In this way, the ink film is firmly fixed or bonded to the recording medium M to have excellent film-forming properties, and an excellent, high-quality image can be obtained in a short time.

The surface temperature of the recording medium M due to the heating by the heater 5 is preferably in the range described in the above-described secondary drying step. When the temperature is within the above range, there is a tendency that an image with high image quality is obtained in a short time.

The ink jet recording apparatus 1 may include the cooling fan 6. After the ink recorded on the recording medium M is dried, by cooling the ink on the recording medium M by the cooling fan 6, an ink coating film can be formed on the recording medium M with good adhesion.

In addition, the ink jet recording apparatus 1 may include the preheater 7 that preheats the recording medium M before the ink is attached to the recording medium M. In addition, the ink jet recording apparatus 1 may include the ventilation fan 8 so that the ink attached to the recording medium M is dried more efficiently.

Below the carriage 9, there are provided the platen 11 that supports the recording medium M, the carriage moving mechanism 13 that moves the carriage 9 relative to the recording medium M, and the transport unit 14 which is a roller that transports the recording medium M in the sub-scanning direction. The operations of the carriage moving mechanism 13 and the transport unit 14 are controlled by the controller CONT.

In another present embodiment, the ink jet recording apparatus may be a line type ink jet recording apparatus, in which the ink jet head 2 is a line head. For example, in FIG. 3, the ink jet head 2 is a line head having a length equal to or greater than the recording width in the width direction of the recording medium, and the position is fixed. The ink is ejected from the ink jet head 2 to the recording medium M being transported, and is attached to the recording medium. In this case, recording is performed by one main scanning. When the ink jet head 2 is a line head, the configuration other than the above may be the same as that in the above-described serial type.

### 3. Examples

Hereinafter, the present disclosure will be described in more detail with reference to examples, but the present disclosure is not limited to these examples.

Hereinafter, “%” is based on mass unless otherwise specified.

### 3.1 Preparation of Maintenance Liquid

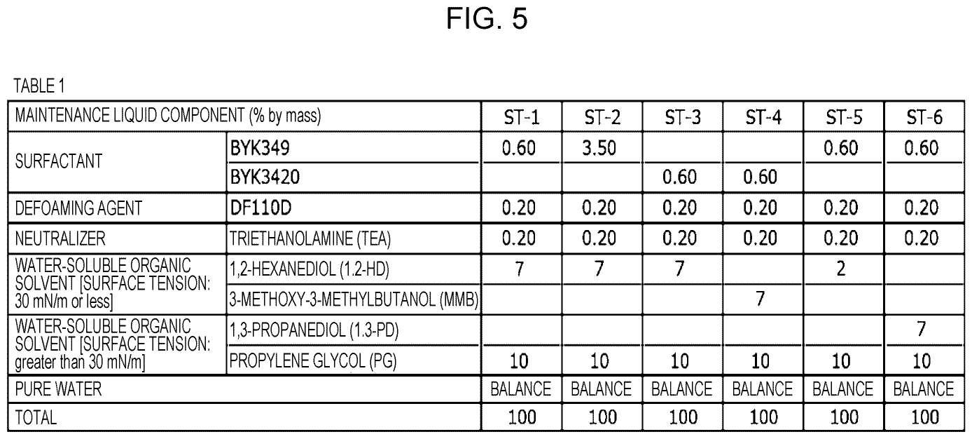

The components are put in a mixture tank so as to have the compositions described in Table 1 (FIG. 5), mixed and stirred, and further filtered through a 5 μm membrane filter to obtain maintenance liquids (ST-1 to ST-6) of the respective examples. Note that pure water is added such that the total mass of the composition becomes 100% by mass.

The description in Table 1 will be supplemented.

### Surfactant

BYK349 (trade name, manufactured by BYK Japan K.K., surface tension as a 0.1% propylene glycol solution at 25° C.:33. 86 mN/m, silicone-based surfactant)
BYK3420 (trade name, manufactured by BYK Japan K.K., surface tension as a 0.1% propylene glycol solution at 25° C.:27 19 mN/m, silicone-based surfactant)

### Defoaming Agent

DF110D (trade name, manufactured by Air Products Japan, Inc.)

The surface tension of the water-soluble organic solvent is measured using an automatic surface tensiometer CBVP-Z (Kyowa Interface Science Co., Ltd.) by checking the surface tension when a platinum plate is wetted with a 20% by mass aqueous solution of the water-soluble organic solvent under an environment of 25° C.

### 3.2. Preparation of Ink Composition

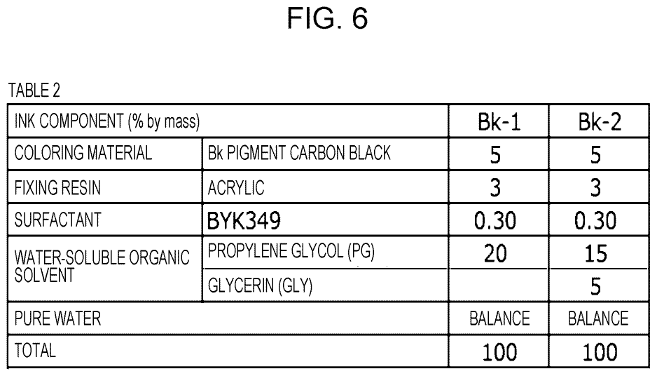

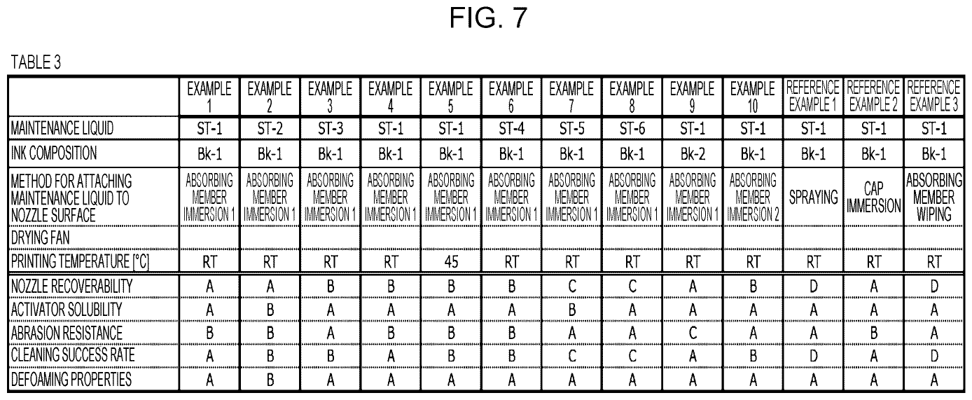

The components are put in a mixture tank so as to have the compositions described in Table 2 (FIG. 6), mixed and stirred, and further filtered through a 5 μm membrane filter to obtain ink compositions (BK-1 and BK-2) of the respective examples. Note that pure water is added such that the total mass of the composition becomes 100% by mass. Each component is the net mass of the component.

The description in Table 2 will be supplemented.

### Coloring Material

Carbon black (“CAB-O-JET300,” trade name, manufactured by Cabot Corporation, solid content: 15%, self-dispersed pigment)

### Fixing Resin

Mowinyl 6969D (trade name, manufactured by The Nippon Synthetic Chemical Industry Co., Ltd., acrylic resin emulsion)

### Surfactant

BYK349 (trade name, manufactured by BYK Japan K.K., surface tension as a 0.1% propylene glycol solution at 25° C.:33. 86 mN/m, silicone-based surfactant)

### 3.3 Printing Conditions

Recording in evaluation tests is based on the following conditions.
Printing machine: SurePress L-4733A (manufactured by Seiko Epson Corporation) modified machine
Recording medium: “PET50A” (trade name, manufactured by Lintec Corporation, PET transparent film)
Printing mode: “film 8 Pass #0”
Recording medium surface temperature at platen (printing temperature): described in Table 3 (RT represents room temperature (25° C.))

In the example with the drying fan being present, air having an air velocity of 10 m/s at 25° C. is blown near the recording medium on the platen.

### 3.4 Maintenance Conditions

“Method for attaching maintenance liquid to nozzle surface” (maintenance conditions) described in Table 3 is as follows:
“Absorbing member immersion 1” means that the maintenance liquid in Table 3 is attached to an absorbing member (“Bemliese,” trade name, manufactured by Asahi Kasei Corporation, cellulose fiber) in an amount of 50 mg/inch², which is brought into contact with the nozzle surface of the ink jet head for a predetermined time to perform leaving-to-stand.
“Absorbing member immersion 2” is the same as absorbing member immersion 1 except that the attachment of the maintenance liquid is 30 mg/inch².
“Spraying” means that the maintenance liquid in Table 3 is sprayed onto the nozzle surface of the ink jet head, which is left to stand as it is for a predetermined time.
“Cap immersion” means that the maintenance liquid in Table 3 is charged into a cap, and the nozzle surface of the ink jet head is immersed in the maintenance liquid for a predetermined time. Note that the maintenance liquid is charged into the cap in such an amount that the nozzle surface is completely immersed therein.
“Absorbing member wiping” means that the maintenance liquid in Table 3 is attached to an absorbing member (“Bemliese”, trade name, manufactured by Asahi Kasei Corporation, cellulose fiber) in an amount of 50 mg/inch², and the absorbing member is reciprocated for a predetermined time while being in contact with the nozzle surface of the ink jet head.

### 3.5 Evaluation Tests

### 3.5.1 Nozzle Recoverability

The ink composition of each example is charged into the printing machine, and printing is performed for 1 hour under the above-described printing conditions in a nozzle misfiring state. Note that air bubbles are intentionally introduced into the nozzles to create a non-ejecting state (the nozzle misfiring state). Thereafter, the maintenance liquid of each example is attached to the nozzle surface under the above-described maintenance conditions described in Table 3, and suction cleaning is performed. The nozzle recoverability is evaluated based on the following determination criteria. Note that an evaluation of C or better is good. Evaluation is made by the number of recovered nozzles (%).

### Determination Criteria

A: 50% or more of clogged nozzles recovered with the predetermined time of the maintenance conditions being 1 minute
B: 50% or more of clogged nozzles recovered with the predetermined time of the maintenance conditions being 3 minutes
C: 50% or more of clogged nozzles recovered with the predetermined time of the maintenance conditions being 4 minutes
D: 50% or more of clogged nozzles not recovered with the predetermined time of the maintenance conditions being 4 minutes

### 3.5.2 Activator Solubility

The maintenance liquid of each example is hermetically put in a container and stored in a thermostatic chamber, and the solubility is evaluated based on the following determination criteria.

### Determination Criteria

A: no separation even with heating at 60° C. for 1 week
B: no separation even with heating at 40° C. for 1 week
C: separation with heating at 40° C. for 1 week

### 3.5.3 Abrasion Resistance

In the evaluation test of “Nozzle Recoverability,” the maintenance is performed with the predetermined time of the maintenance conditions being 4 minutes, recording is performed by the recording apparatus in which the maintenance is performed, the obtained printed matter is rubbed 50 times by a Gakushin type abrasion resistance tester (load: 500 g), the degree of peeling of the ink is visually checked, and the abrasion resistance is evaluated based on the following determination criteria.

### Determination Criteria

A: no occurrence of peeling
B: peeling of 10% or less
C: peeling exceeding 10%

### 3.5.4 Cleaning Success Rate

The ink composition of each example is charged into the printing machine, the nozzle surface of the ink jet head is left to stand at a position facing the platen for 30 minutes under the printing conditions, then the maintenance of each example is performed with the predetermined time of the maintenance conditions being 1 minute, and after the maintenance, suction cleaning is performed. The cleaning success rate is evaluated based on the following determination criteria. Note that an evaluation of C or better is good.

### Determination Criteria

A: no occurrence of non-ejecting nozzles after performing cleaning once
B: no occurrence of non-ejecting nozzles with two-time cleaning
C: no occurrence of non-ejecting nozzles with three-to-four-time cleaning
D: occurrence of non-ejecting nozzles with four-time cleaning

### 3.5.5 Defoaming Properties

The maintenance liquid of each example is put in a glass screw tube, and the time until the foam disappears after stirring 20 times is measured, and the defoaming properties are evaluated based on the following determination criteria.

### Determination Criteria

A: bubbles disappearing within 12 hours
B: bubbles disappearing within 24 hours
C: bubbles not disappearing even after 24 hours or more

### 3.6 Evaluation Results

The evaluation results are shown in Table 3.

From the results described in Table 3, all of the maintenance methods according to the respective examples, each of which is a maintenance method for a recording apparatus including an ink jet head having a nozzle that ejects a water-based ink composition, the maintenance method including a leaving-to-stand step of performing leaving-to-stand with a nozzle surface in which the nozzle of the ink jet head is formed being in contact with an absorbing member containing a maintenance liquid, are excellent in nozzle recoverability.

Note that when the same procedure was performed as in Example 1 except that the absorbing member was brought into contact with the nozzle surface for a predetermined time after the maintenance liquid was attached to the nozzle surface, the results of the evaluation tests are the same as those of Example 1.

On the other hand, Reference Examples 1 and 3, which do not satisfy the above configuration, are inferior in nozzle recoverability. In addition, in Reference Example 2, the amount of the maintenance liquid used cannot be reduced.

The following contents are derived from the above-described embodiments.

An aspect of a maintenance method is a maintenance method for a recording apparatus including an ink jet head having a nozzle that ejects a water-based ink composition, the maintenance method including a leaving-to-stand step of performing leaving-to-stand with a nozzle surface in which the nozzle of the ink jet head is formed being in contact with an absorbing member containing a maintenance liquid.

In the aspect of the maintenance method, a leaving-to-stand time of the leaving-to-stand step may be 1 minute or more.

In any aspect of the maintenance method, the maintenance liquid may be attached to the nozzle surface, and the nozzle surface to which the maintenance liquid is attached may be brought into contact with the absorbing member to perform the leaving-to-stand, or the maintenance liquid may be attached to the absorbing member, and the nozzle surface may be brought into contact with the absorbing member to which the maintenance liquid is attached to perform the leaving-to-stand.

In any aspect of the maintenance method, a content of the maintenance liquid of the absorbing member in the leaving-to-stand step may be 30 mg/inch² or more.

In any aspect of the maintenance method, the maintenance liquid may contain a water-soluble organic solvent having a surface tension as a 20% aqueous solution at 25° C. of 30 mN/m or less in an amount of 3% by mass or more with respect to a total mass of the maintenance liquid.

In any aspect of the maintenance method, the water-soluble organic solvent may be an alkanediol having 6 or more carbon atoms.

In any aspect of the maintenance method, the recording apparatus may eject the ink composition from the nozzle to perform recording on a low-absorbent recording medium or a non-absorbent recording medium.

In any aspect of the maintenance method, after the leaving-to-stand step, a suction step of performing suction from the nozzle, and a wiping step of wiping the nozzle surface with the absorbing member may be included.

In any aspect of the maintenance method, the ink composition may have a content of a polyol having a standard boiling point of 250° C. or higher as an organic solvent of 1% by mass or less with respect to a total mass of the ink composition.

In any aspect of the maintenance method, the maintenance liquid may contain a surfactant having a surface tension as a 0.1% propylene glycol solution at 25° C. of 30 to 35 mN/m.

In any aspect of the maintenance method, the maintenance liquid may be water-based.

An aspect of a recording apparatus is a recording apparatus that performs maintenance by the maintenance method according to any aspect of the maintenance method, the recording apparatus including the ink jet head, the absorbing member, and the maintenance liquid.

In the aspect of the recording apparatus, a drying mechanism that performs a primary drying step when performing recording may be included.

The present disclosure is not limited to the above-described embodiments, and various modifications are possible. For example, the present disclosure includes substantially the same configurations as the configurations described in the embodiments, for example, configurations having the same functions, methods, and results, or configurations having the same objects and effects. The present disclosure includes configurations in which non-essential portions of the configurations described in the embodiments are replaced. In addition, the present disclosure includes configurations that achieve the same operational effects or configurations that can achieve the same objects as those of the configurations described in the embodiments. In addition, the present disclosure includes configurations in which a known technique is added to the configurations described in the embodiments.

What is claimed is:

1. A maintenance method for a recording apparatus including an ink jet head having a nozzle that ejects a water-based ink composition, the maintenance method comprising:
a leaving-to-stand step of performing leaving-to-stand with a nozzle surface in which the nozzle of the ink jet head is formed being in contact with an absorbing member containing a maintenance liquid.

2. The maintenance method according to claim 1, wherein a leaving-to-stand time of the leaving-to-stand step is 1 minute or more.

3. The maintenance method according to claim 1, wherein the maintenance liquid is attached to the nozzle surface, and the nozzle surface to which the maintenance liquid is attached is brought into contact with the absorbing member to perform the leaving-to-stand, or the maintenance liquid is attached to the absorbing member, and the nozzle surface is brought into contact with the absorbing member to which the maintenance liquid is attached to perform the leaving-to-stand.

4. The maintenance method according to claim 1, wherein a content of the maintenance liquid of the absorbing member in the leaving-to-stand step is 30 mg/inch² or more.

5. The maintenance method according to claim 1, wherein the maintenance liquid contains a water-soluble organic solvent having a surface tension as a 20% aqueous solution at 25° C. of 30 mN/m or less in an amount of 3% by mass or more with respect to a total mass of the maintenance liquid.

6. The maintenance method according to claim 5, wherein the water-soluble organic solvent is an alkanediol having 6 or more carbon atoms.

7. The maintenance method according to claim 1, wherein the recording apparatus ejects the ink composition from the nozzle to perform recording on a low-absorbent recording medium or a non-absorbent recording medium.

8. The maintenance method according to claim 1, further comprising, after the leaving-to-stand step, a suction step of performing suction from the nozzle, and a wiping step of wiping the nozzle surface with the absorbing member.

9. The maintenance method according to claim 1, wherein the ink composition has a content of a polyol having a standard boiling point of 250° C. or higher as an organic solvent of 1% by mass or less with respect to a total mass of the ink composition.

10. The maintenance method according to claim 1, wherein the maintenance liquid contains a surfactant having a surface tension as a 0.1% propylene glycol solution at 25° C. of 30 to 35 mN/m.

11. The maintenance method according to claim 1, wherein the maintenance liquid is water-based.

12. A recording apparatus that performs maintenance by the maintenance method according to claim 1, the recording apparatus comprising:
the ink jet head;
the absorbing member; and
the maintenance liquid.

13. The recording apparatus according to claim 12, further comprising a drying mechanism that performs a primary drying step when performing recording.
